(19) United States
(12) Patent Application Publication
(10) Pub. No.: US 2017/0061820 A1
(43) Pub. Date: Mar. 2, 2017

(54) GOAL BASED MONETARY REWARD SYSTEM

(71) Applicant: Babak Firoozbakhsh, Marietta, GA (US)

(72) Inventor: Babak Firoozbakhsh, Marietta, GA (US)

(21) Appl. No.: 15/058,151

(22) Filed: Mar. 2, 2016

Related U.S. Application Data
(60) Provisional application No. 62/126,689, filed on Mar. 1, 2015.

(51) Int. Cl. G09B 19/00; G09B 5/12; G06Q 20/10

(52) U.S. Cl. CPC G09B 19/0092; G06Q 20/10; G09B 5/125; G09B 19/00

(57) ABSTRACT

The present is a system for encouragement or discouragement of certain achievement or failure of the user respectively. This system encourages the users to perform desirable activities and discouraging users from performing undesirable activities. It further includes steps involving fulfilling one's resolution, which further may include financial punishment for meeting the goal or milestone for the activity that would lead the user to a desired goal.

This application claim priority to the provisional application titled “Methods and systems for encouragement and/or discouragement of certain achievements or behaviors” identified by No. 62/126,689 and filed on Mar. 1, 2015.

### BACKGROUND OF THE INVENTION

Many people have desired goals or outcomes that they work towards. However, there often is a lack of a mechanism defined by the user or a third party to encourage or push towards achieving those goals. There may be certain beneficial activities that a person may need some external motivation to do, and similarly, there may be unbeneficial or harmful activities that may need external discouragement in order for the person to avoid. Such examples may often be found in a parent-child relationship. The parent may wish to encourage the child to study and exercise, or to visit the library or the gym. The parent may also wish to discourage the child from smoking, drinking alcohol, visiting game rooms, or staying out late. Currently a system used for encouraging/discouraging the achievement or failure of the user is not incorporated with the example system wherein the user of the system himself/herself can set his/her goals and can set the penalty or reward for the achievement or failure of his/her goal respectively. Similarly, a system used for encouraging/discouraging achievement or failure of the user is not incorporated with the example system wherein a third party can set the goal(s) for the user and can set the penalty or reward for the achievement or failure of the goal(s).

In addition to this these system, are also not providing its applicability in different fields other than health goals, wherein the different units used by the present system do not have a tracking system to determine user's location or place(s) visited by the user as well as the payment system is only limited by card payment or by physical payment.

There remains a need to overcome above mentioned problems and in the present invention the above mentioned problems have been solved.

### SUMMARY OF THE INVENTION

The present invention provides method or a system for encouragement or discouragement of certain achievement or failure of the user respectively. This system encourages the users to perform desirable activities and discouraging users from performing undesirable activities. Moreover, this system consists of methods or steps involved to encourage fulfilling one's resolution, which further includes financial punishment or other punishment for not meeting the goal or milestone or not following through with the activity that would lead the user to the desired goal.

The present invention provides a system, which includes identifying new user's identity using at least one of the following: using one or more biometric sensors, scanning (reading) of any identifying cards of the user, scanning or reading a bar code or QR code or other graphical or numeric or alphanumeric code, scanning or reading a near-field communication device or tag (e.g., RFID tag, or NFC or Bluetooth tag), receiving identifying communication from a user's phone or mobile device, reading a bank card or credit card associated with the user, scanning or reading existing account of the user, scanning one or more devices used by the user, scanning the user's face through a still camera or a video (motion) camera, speech recognition, or audio recognition, or a password or passcode entered by the user. In one embodiment of this invention the user himself/herself sets one or more goal(s) which has/have to be completed within a set time frame. Thereafter, the user also specifies the price he/she is willing to pay for failure to reach the goal(s) and can also select the reward for the successfully reaching the goal(s). There may be some restrictions imposed by the system, for example, limiting the reward amount to be less than or equal to the fee collected or the punishment specified; or for the reward amount to be a fraction, equal to, or a multiple of the price/punishment that the user is willing to pay or a fraction, equal to, or a multiple of his/her pre deposited or pre-specified fund or the funds collected from or donated by other users. In addition to this, decision unit determines if the goal was achieved by the user and determines the penalty or reward associated with the success or failure of the user's ability to reach the goal. The payment processing unit pays the user (or refunds previously collected funds or a multiple or a percentage of the previously collected funds) or charges the user (or keeps previously collected funds or a percentage of the previously collected funds) based on the success or failure of the user to achieve the set goal. The system herein for monitoring information related to an activity, or characteristic, or location of a user having a device comprising a display, a microprocessor and a communication transceiver, the device comprising a server comprising a central processing unit, a memory, a clock, the memory having location data stored therein, and the central processing unit programmed to identify a user's identity using an identifying unit; set a goal using a goal setting unit, wherein the goals setting unit enables the user or a third party to set at least one goal and associate monetary or other means of reward or punishment with the at least one goal; track the at least on goal using a tracking and measurement unit, wherein the tracking unit tracks at least one goal or activity or characteristic or location; communicate between at least two units using a communication unit, wherein the communication unit enables communication between the at least two units; storing information about the user in a storage unit; determines success or failure of the user in achieving the at least one goal based on at least one input from the tracking and measurement unit relating to the at least one goal using a decision unit; decision unit determines the penalty or reward based on the level of success or failure of the user; and reward the user using a reward fulfillment unit, wherein the reward unit enables processing of payment information and reward corresponding to an output of the decision unit. The system of the present invention is having a mobile device comprising a GPS receiver, a display, a microprocessor and a wireless communication transceiver coupled to the GPS receiver, the mobile device programmed to receive PN codes sent by a plurality of GPS satellites, calculate pseudo-ranges to the plurality of GPS satellites by averaging the received PN codes, and transmit the pseudo-ranges, and a server comprising a central processing unit, a memory, a clock, and a server communication transceiver that receives pseudo-ranges from the wireless communication transceiver of the mobile device, the memory having location data stored therein for a plurality of wireless towers, and the central processing unit programmed to.

### DESCRIPTION OF THE INVENTION

The system herein for monitoring information related to an activity, or characteristic, or location of a user having a device comprising a display, a microprocessor and a communication transceiver, the device comprising a server comprising a central processing unit, a memory, a clock, the memory having location data stored therein, and the central processing unit programmed to identify a user's identity using an identifying unit; set a goal using a goal setting unit, wherein the goals setting unit enables the user or a third party to set at least one goal and associate monetary or other means of reward or punishment with the at least one goal; track the at least on goal using a tracking and measurement unit, wherein the tracking unit tracks at least one goal or activity or characteristic or location; communicate between at least two units using a communication unit, wherein the communication unit enables communication between the at least two units; storing information about the user in a storage in a storage unit, determines success or failure of the user in achieving the at least one goal based on at least one input from the tracking and measurement unit relating to the at least one goal using a decision unit; decision unit determines the penalty or reward based on the level of success or failure of the user; and reward the user using a reward fulfillment unit, wherein the reward unit enables processing of payment information and reward corresponding to an output of the decision unit. Other embodiments of the invention include two or more of the following modules/systems within a system or device or hardware or software:
a. A tracking and measurement system to measure personal or physical characteristics (e.g., scale/weight measurement system, height measurement system, body fat measurement system, Biometric Impedance measurement system, body fat analyzer, body mass index measurement system, muscle mass measurement system, waist size measurement system, camera, microphone, etc.) or to measure health/vital signs (e.g., blood pressure, blood sugar/glucose/sucrose, insulin, cholesterol, blood oxygen, pulse, heart rate, body temperature, galvanic response, etc.) or to measure or determine activity (e.g., pedometer, position sensor, GPS, magnetometer, accelerometer, pulse measurement system, calorie measurement system, activity measurement or mapping system, oxygen intake measurement system, airflow sensor, sweat measurement system, elevation/climbing measurement system, barometer, etc.) or other measurement systems directly or indirectly dealing with one's health (e.g., blood alcohol measurement system, breath alcohol measurement systems, breathalyzers, drug tests/measurement systems, nicotine measurement systems, electrocardiogram sensor, electromyography sensor, etc.) or a system determining meeting certain goal(s) or keeping up with certain goal(s), [e.g., location-tracker, Electronic Medical/Health Recor(s), tracker of web site(s) visited, etc.].
b. A communication system to communicate the information from the measurement or tracker system. This may be wireless or via a physical connection such as wire, cable, optical fiber, etc.
c. A storage system to store the measurement(s) or a subset of the measurement(s) or results from analysis of the measurement(s) or some characteristic(s) of the measurement(s) or to store the tracked data/tracking result(s) or subset of tracked data/tracking result(s) or some characteristics of the tracked data/tracking result(s).
d. A system/unit for collection and/or processing of payment information (E.g., for input of credit card or debit number whether by swiping or scanning or tapping a card or phone or RFID or by manual input via keyboard or touchpad or virtual keyboard or audio) This may include means for communication with the credit card processing center, verification means (whether through signature, audio, video, biometric data such as finger print, voice, retina, etc.).
e. The ability (whether as part of a different module or a subsystem of another module) to identify the user. This may include login name and password verification using our own system (e.g., with the option for the user to create a new account), verification using other existing accounts such as paypal, facebook, google, gmail, twitter, etc., ability to identify the user via biometric sensor(s), such as fingerprint recognition, voice recognition, retina scan, ability to identify the user from the device being used (e.g., the user's phone/handset/digital wallet/specialized card/RFID), ability to identify the user from credit/debit/id card(s) with or without additional info such as pin number, password, etc.
f. A system for the user to input the future planned goal or milestone(s) (e.g., for personal or physical or vital or health characteristics), the time frame(s) when the goal(s) has/have to be reached (e.g., next week, next month, by a certain date, over a certain period, etc.), or/and a plan (e.g., ¼^{th} of desired goal or milestone to be reached at each ¼^{th} of the total time frame), and a price that the user is willing to pay if he/she does not meet or reach his/her goal(s) or milestone(s) or what percentage of (total) fee to be paid for each percentage of failure (discrepancy from the desired goal) or the price or fee that the user would pay if he/she does not show up on the designated date or designated date plus/minus a grace period to the designated place or the price or fee that the user would pay if he/she does not complete the designated task or measurement by the designated date plus/minus a grace period. Alternatively, the user (or another person/party) may select the amount that the user would be rewarded (for example, from his own pre-deposited funds or from funds collected from a group or donated or made as gift from other(s)) if he/she meets his or her goal(s)/milestone(s), or the percentage(s) that the user would be rewarded for meeting his/her milestones or partial goals based on percentages of success or milestone completion or/and time of success/milestone completion. Examples of personal/physical characteristics include: weight, height, body mass index, body fat, muscle mass. Examples of vital or health characteristics include: blood pressure, blood sugar/glucose, cholesterol, heart rate/pulse rate, vitamin levels, triglyceride level, HLD cholesterol, LDL cholesterol, body nicotine content, blood alcohol level.
g. System to identify certain actions by the user. For example, GPS or Geolocation or triangulation data to determine the user's location or place(s) visited, or information from merchant(s) or credit card(s) to determine if the user has purchased certain good(s) or visited certain places (e.g., tobacco, alcohol, fast food, etc.) or web site tracking, cookie tracking, information from network providers regarding web site(s) visited, keyboard clicks, keyboard data, mouse data, cell phone data, call data, etc.
h. Some of the modules may be hardware modules or may incorporate hardware, whereas some maybe software modules or incorporate software modules. The system can either punish missed goals/resolution(s)/milestone(s) or reward achieved goal(s)/resolution(s)/milestone(s) (or do both) by:

Charging the user when/if he/she does not meet his/her personal goal or milestone, thereby punishing them and encouraging the person to try to meet their goal/resolution. This can be a service charge that the user determines and is charged if he/she misses his/her goal. If the goal or milestone is met, the service charge is waived or reduced.

Charging the user when he/she inputs the promise/goal/resolution/milestone, and rewarding them by returning/refunding the charged amount (or a portion of the charged amount) when he/she meets his/her promise/goal/resolution/milestone. Otherwise (if the user has not met his/her promise/goal/resolution/milestone), not returning/not refunding the charged amount or returning only a portion of the charged amount. For example, this may be implemented by charging a service fee decided by the user and then refunding the service fee (or refunding the service fee minus a percentage or amount for administration fees) if the personal goal/resolution/promise/milestone is successfully reached.

Allowing a person to pay the fee(s) or/and reward(s) for another person and set (a) resolution(s)/goal(s)/milestone(s) for them, thereby encouraging them to work towards the goal(s) and be rewarded if they meet the goal. Some of the sample implementations are listed below:
a. The reward or (reward+fee) or fee amount can be collected up front and if the intended/specified goal/milestone/resolution is reached, the reward amount or the reward+fee amount or fee amount or a portion of the reward or a portion of the reward+fee amount or a portion of the fee amount would be rewarded to the person who has achieved the goal/milestone/resolution; if the goal/milestone/resolution is not achieved, then a portion of the reward or all of the reward or none of the reward or a portion of a specified fee or all or none of the specified fee or a portion of or all or none of the reward+fee amount may be refunded and the rest maintained by our system.
b. In case the intended person has achieved the intended goal/milestone/resolution, then the reward amount or fee or reward+fee can be collected from the person setting up the reward (e.g., deducted from his/her credit or debit card or bank account) and either all or a portion of the reward or fee or reward+fee would be rewarded to the person achieving the goal (if a portion of the money collected is rewarded, the other portion can be charged for our services or allocated to other causes). In case the intended person did not achieve his/her goal/milestone/resolution, all or a portion of or none of the reward amount or fee or reward+fee can be deducted from the person setting up the reward (e.g., from his/her debit or credit card or bank account). Please note that in some implementations of the invention the fee may even be set up as zero.
c. In other examples, any combination of the following may be implemented:
   c1. Person A may be rewarded in case of person A's success
   c2. Person A may be punished in case of person A's failure
   c3. Person B may be rewarded in case of person B's success
   c4. Person B may be punished in case of person B's failure
   c5. Person B may be rewarded in case of person A's failure
   c6. Person A may be rewarded in case of person B's failure
   c7. Person B may be rewarded in case of person A's success
   c8. Person A may be rewarded in case of person B's success
   c9. Other parties (e.g., Person C or/and Person D) may rewarded or punished based on their own success/failure or/and other person's success/failure or/and other group/set of persons' success/failure.

In the above scenarios, the source of the funds may be from any or any combination of the persons involved or not involved. For example, the source of funds may any combination of: person A, person B, person C, person D, the person who succeeded, the person who failed, external people who neither succeeded nor failed, etc.

Other flavors include giving the ability for people to set competition with each other.
i. For example, a number (n) of users may set up a goal-driver or activity-driven reward/punishment system, where the defined total amount of money (Tn) from the n users will be divided according to a pre-set criteria (e.g., equally) among the winners. Alternatively, a fee (preset amount or percentage or even zero fee equivalent to no fee) may be imposed for the service by our system. For example, p percent of the Total amount collected (p % of Tn) may be divided among the w winners, and (1−p) percent of the total Tn (i.e., (1−p)*Tn) will be collected as our service fee/profit.
ii. As another example, a system may be set up where those who fail in reaching the specified goal(s)/milestone(s) or who broke certain promise(s)/resolution(s) {e.g., showed up to places where they were not supposed to, visited web sites they were not supposed to, failed to show up to places where they were supposed, missed or were late for appointments, missed certain desired/promised activities or performed some undesirable activities) pay those who achieved those specified goal(s)/milestone(s) or were successful in keeping their promise(s)/resolution(s).
iii. Another example would be to define the reward (Rn) for each person's goal achievement(s). A goal may include avoidances of certain activities or performance of certain activities or certain achievement(s) too). Goals may be performance-based, behavior-based, activity-based, or based on certain avoidances. The participants may betting against each other and z % the money that comes from those who lose will be distributed among those who win (and 1−z % will go to us as profit).
iv. Our systems and methods may even be set up in (a) way(s) where we risk some loss in case of success or failure of the participant(s) as well, effectively, our system being a participant as well. However, there will be some risk management needed to prevent complete losses to us.

As another alternative, rewards upward of fees collected may be included. For example, our system may actually reward certain goals or achievement(s) from our own funds our revenue or profit(s) or fund(s) from other participant(s) in our other goal/achievement/resolution reward/punishment system. E.g., we may say x % of our profits will be distributed according to certain rules (e.g., equally or proportionally to risk involved to the participant or amount spent by the participant or proportional to level of achievement) to the top y % of those who achieved their goal(s)/resolution(s).

As another example, the system may reward participants based on their performance, e.g., rewarding the top x % of performances according to their performance. For example, consider a race where n participants participate and the top m achiever(s) are rewarded. E.g., 10 participants may participate and top 3 rewarded based on their percent body weight loss or 20 may participate in a running race and the fastest 3 (the 3 who reach the destination in the shortest amount of time) would get rewarded based on certain pre-determined reward system which may o may not take into account the level of success (e.g., may be pre-set to say pay xxx amount to first place, yyy to second place and zzz to third place winner; or may be pre-set to pay proportional to the level of achievement, e.g., proportional to the percent body weight lost to each of the winners receiving an award).

Our system may even introduce a way for the user to “tip” our system. For example, if the user has met his/her goal(s) and has received his/her reward or avoided his/her punishment, our system can give them the option to “tip” an amount chosen or entered by the user to our system in appreciation of encouraging him/her to reach his/her goal(s). Other sources of revenue, such as advertisement may be integrated with our system. The reward or punishment may even be in the form of real or virtual goods or services or credit(s) purchased through our system. For example, the person may purchase certain avatars or the option to use our system/software for other goal(s) or may buy certain products through our set of offered products or services. Likewise, for punishment the system may associate an avatar of “shame” with the user, which the user would pay for to have removed. The system may also include donations. e.g., donations made to a favorite charity in case of loss or in case of achievement. In addition to the traditional rewarding systems, other alternatives may be used. For example, the user may purchase a gift card for a certain amount, but the value of the gift card may not be set until the specified date and based on the level of achievement of the goal. The system(s)/subsystem(s) specified may be integrated and working together as one larger system or distributed among several system(s). For example, one company or system performing a portion of the work and another performing another portion of the work.

Listed below, please a few non-limiting examples demonstrating some exemplary embodiments of our invention:

EXAMPLE 1: one could make a simple scale that is used at the gym, equipped with the credit card system and system for transferring or storing the person's weight and future desired weight and track their progress, etc. The system may display the current weight of the user and prompt them for what their desired weight would be by certain date(s). Furthermore the system may prompt the user to enter how much they want to reward themselves if meeting their goal (e.g., losing the amount of weight in the time period/by the date specified) or how much they want to punish themselves for not meeting that goal. There can even be a gradual encouragement/discouragement (reward/punishment) system. For example, if the person wants to reach a certain weight in 3 months, the system can give them the option to drop the weight by ⅓rd of the difference every month or 1/12th of the difference every week, and specify a reward/punishment for each portion/milestone of the goal. The same concept can be applied to blood pressure (e.g., integrated with blood pressure monitors, or other devices monitoring any body signs, vital signs, personal characteristics, etc. Example 2. An app or software can be developed which allows the user to specify the number of steps they want to take/walk/run/climbing in a certain period of time (e.g., every day or every week), and the reward (e.g., monetary amount) for meeting that goal or punishment (monetary fee) for not meeting that goal. If the goal of taking/walking/running/climbing those number of steps in that period of time is met the user can be rewarded. Likewise if the goal is not met, the user can be punished. Any of the rewarding systems specified above may be used . . . others may encourage a loved one to take a certain number of steps by setting a reward for them, different users can set up a health “competition” among themselves where they all contribute to the reward/punishment amount, and so on. For example someone who works at the gym can make a promise to spend at least an hour at the gym once a day, which for them is easily achievable . . . or people can find ways to beat the system and make money. That's why I think the safer approach develop the punishment system (of course we do offer reward in the form of refunding their fee) and then depending on demand, we can tweak the software to include rewards as well. (that change is not a difficult change and can be put in place if we see the necessity for it), and there are many different flavors that can be applied . . . for example the reward being the original amount they bet (their suggested service fee) plus x % interest, or we can even say that the x % of the profits collected from losses (in an equivalent period) will be divided between the winners proportional to their bet. As another example, an app may be used which tracks the user's location(s). Say the user wants to dedicate m number of minutes or h number of hours per p period of time (e.g., a day) to attend a destination (e.g., a gym or a meditation class or church or the library) or to attend a category/class of destination(s) (e.g., any gym or any library). Any system of reward/punishment similar to the ones previously discussed can be implemented for the user meeting his/her goal(s) to attend to the destination or the category of destination(s) or not. Likewise, a destination or category of destination may be desired to be avoided (e.g., fastfood restaurants, bars, smoke shops, etc.). The same type of reward/punishment system can be set up for avoiding those destination(s) or category of destination(s) or failing to avoid those destination(s)/category of destination(s). Similarly, the destination may be certain web sites or category of web site(s) that the user wants to visit regularly or wants to avoid. As another example, a software or app may be developed related to the user's productivity by tracking actual amount of time actively working on the computer without surfing certain recreational web site(s) or category of web site(s) or with the mouse or keyboard actively engaged or the computer's web cam tracking the user being in front of the monitor. Similar reward/punishment system(s) can be incorporating for meeting or not meeting such productivity goals. As another example, the system may even integrate with EMR's or health management systems to reward the user/patient for following the doctor's orders and punishing the user for not doing so. For example, the system maybe integrated with a pill dispenser or a mechanism that tracks the pill actually being consumed by the user. In case of meeting the goal of taking the pills within desired interval(s) of times, the user can be rewarded and in case of failure the user can be punished monetary or via other means (e.g., reports to insurance companies, etc.). Another example would be a system/software on Phone or PC to monitor use of certain programs or apps or visiting certain sites or contacting specific set of people or a person, in order to prevent/reduce the use of certain apps or web sites (e.g., facebook, twitter, sms messaging, news sites, web sites, internet explorer, etc.) or prevent or reduce them during certain hours or times of the day. Yet another example would be a System/software remotely monitoring a specific phone or PC or router to prevent/reduce use of certain apps or web sites. This time the software is not on the person's phone or computer, but the service is remotely monitoring such actions via the internet.
Other examples include:
A medication/pill dispensing system integrated with the above technology to insure that the person sticks to the medication schedule specified with the doctor (may be integrated with a video camera as a means of insuring taking the medication or not integrated with the video camera, which ever you recommend)
A wearable (e.g., wrist band) or foot band or pedometer with the ability to directly interface with the user to set and monitor the goals or to indirectly (e.g., via a mobile phone/wirelessly) integrate with the specified system.
An exercise machine (e.g., treadmill or exercise bike or rowing machine) which would allow the person to set up such goals and rewards/punishments (e.g., for showing up x times in a d-day period or for using the device m minutes in a d-day period or for burning x calories or walking/running/biking z miles)
An actual moving bicycle or a unicycle or a roller blade or a hoverboard or skateboard with the additional capability to communicate with the user either through a built in human interface (e.g., monitor and keyboard or voice) or through a wirelessly connected interface (e.g., via a mobile phone connected to the device via Bluetooth or other wireless mechanisms), giving the user the capability to set the goals of using the device for a certain amount during a specified period of time, or setting the goals of traveling z miles or burning c calories over a specified period of time, and specifying rewards or/and punishment and so on.
A ball or jump rope or weight set or toy that would communicate with a backend system (E.g. a phone or the internet) to inform of the amount of use and for the user to be able to set achievement goals, etc.

In the present invention, the goal setting unit enables the user to set one or more desired goal(s) which is/are to be completed within a desired time frame(s). The user also associates the desired goal with a desired monetary price (or other rewards as specified in the patent document) which he is willing to pay or gain after achieving or losing the desired goal. For example, the monetary price can be a pre deposited fund of the user or the funds collected/donated by other users of the system or by a third party. The third party may be any person or group or organization other than the user or any automated system other than the specified system in this patent. In another example, the user may identify the amount and source of the payment (for example credit card information), but the funds would not be collected until the specified time/date. The desired time frame includes at least one of day, week, month, certain date and certain period. The desired goal includes at least one of:
a. personal or physical characteristics such as but not limited to height, weight, body fat, body mass, lean body mass, muscle mass, waist size, etc.
b. vital or health characteristics such as but not limited to Blood pressure, blood sugar, blood glucose, A1C level, blood sucrose, insulin, cholesterol, LDL, HDL, blood oxygen, pulse, heart rate, body temperature, galvanic response etc.
c. other characteristics such as but not limited to alcohol intake, drug intake, nicotine intake, amount of alcohol or nicotine detected in breath or blood, or urine, etc.
d. physical activities, which may be detected by accelerometer, wearable devices or sensors, gyrometers, pulse rate, pedometers, other sensors.
e. compliance with certain activities or regimens as determined by specialized devices. For example, a specialized pill dispenser with the ability to record or communicate the specific time of use (corresponding with pill withdrawal), or a specialized sensor to determine actual swallowing of the pill/medication, or a video camera with the ability to analyze the user's specific activities such as taking a medication.
f. Third party confirmation of certain activity or achievement. For example, a third party monitoring service verifying medication compliance by the user. In a specific example, the user may start the video conference via any device (e.g., a pill dispenser equipped with a camera or a mobile phone) to a third party monitoring service that can verify the specific activity (for example that the user took his/her medication as verified via video)
g. attending or going to a specific location or vicinity of a location once or several times or avoiding or not going to a specific location or vicinity of a location.
h. attending or going to location categorized as a type of location which is desired to be attended (e.g., library or gym) or avoiding going to locations associated with a certain category of locations that is desired to be avoided by the user (e.g., fast food restaurants, bars).

the tracking and measurement unit tracks any metrics or specifications that are used to determine success or failure of the goal or progress towards or away from the goal. For example, the tracking and measurement unit can determine the absolute or relative location of the user using the GPS, geolocation, triangulation data, information of the merchant or credit card to determine goods purchased by the user, website tracking, cookie tracking, information from network providers regarding website visited, cell phone data etc to track the activities of the user.

In another example, the tracking and measurement unit can measures the characteristics of the user corresponding to the goal set by the user, wherein the characteristics are at least one of:
a. personal or physical characteristics such as but not limited to height, weight, body fat, body mass, lean body mass, muscle mass, waist size, etc.
b. vital or health characteristics such as but not limited to Blood pressure, blood sugar, blood glucose, A1C level, blood sucrose, insulin, cholesterol, LDL, HDL, blood oxygen, pulse, heart rate, body temperature, galvanic response etc.
c. other characteristics such as but not limited to alcohol intake, drug intake, nicotine intake, amount of alcohol or nicotine detected in breath or blood, etc.
d. physical activities, which may be detected by accelerometer, wearable devices or sensors, gyrometers, pulse rate, pedometers, other sensors.
e. other physical activities as determined by specialized devices. For example, a specialized pill dispenser with the ability to record or communicate the specific time of use (corresponding with pill withdrawal), or a specialized sensor to determine actual swallowing of the pill/medication, or a video camera with the ability to analyze the user's specific activities such as taking a medication.
f. A third party confirmation of certain activity or achievement. For example, a third party monitoring service verifying medication compliance by the user. In a specific example, the user may start the video conference via any device (e.g., a pill dispenser equipped with a camera or a mobile phone) to a third party monitoring service that can verify the specific activity (for example that the user took his/her medication as verified via video)
g. attending or going to a specific location or vicinity of a location once or several times or avoiding or not going to a specific location or vicinity of a location.
h. attending or going to location categorized as a type of location which is desired to be attended (e.g., library or gym) or avoiding going to locations associated with a certain category of locations that is desired to be avoided by the user (e.g., fast food restaurants, bars). The tracking may be one-time or recurrent.

The communication unit, wherein the communication unit is wired or wireless and which enables communication between the different units.

The decision unit determines success or failure (or level of success or failure) of the user to achieve his/her goal(s) based on the input from the tracking and measurement unit and the previously set goals by the user. The decision unit determines the penalty or reward based on the level of success or failure of the user.

The reward/punishment fulfillment unit executes the reward/punishment as determined by the decision unit. For example, it may consist of a payment processing unit to processes the payment information related to the set goal and pay or deduct the payment of the user corresponding to the success or failure of the task of the user.

While the invention has been described in detail with specific reference to preferred embodiments thereof, it is understood that variations and modifications thereof may be made without departing from the true spirit and scope of the invention.

What is claimed is:

1. A system for monitoring information related to an activity, or characteristic, or location of a user having a device comprising a display, a microprocessor and a communication transceiver, the device comprising a server comprising a central processing unit, a memory, a clock, and the central processing unit programmed to:
identify a user's identity using an identifying unit;
set a goal using a goal setting unit, wherein the goals setting unit enables the user or a third party to set at least one goal and associate monetary or other means of reward or punishment with the at least one goal;
track the at least on goal using a tracking and measurement unit, wherein the tracking unit tracks at least one goal or activity or characteristic or location;
communicate between at least two units using a communication unit, wherein the communication unit enables communication between the at least two units;
storing information about the user in a storage unit;
determines success or failure of the user in achieving the at least one goal based on at least one input from the tracking and measurement unit relating to the at least one goal using a decision unit; decision unit determines the penalty or reward based on the level of success or failure of the user; and
reward the user using a reward fulfillment unit, wherein the reward unit enables processing of payment information and reward corresponding to an output of the decision unit.

2. The system of claim 1, wherein at least one characteristics of the user is a physical characteristic which comprises at least one of height, weight, body Fat, body mass, lean body mass, waist size, posture, etc.

3. The system of claim 1, wherein at least one characteristics of the user is a health characteristic which comprises at least one of blood pressure, blood sugar, blood glucose, A1C level, blood sucrose, insulin, cholesterol, LDL, HDL, blood oxygen, pulse, heart rate, body temperature, galvanic response etc.

4. The system of claim 1, wherein at least one characteristics of the user further comprises alcohol intake, drug or nicotine intake.

5. The system of claim 1, wherein the communication unit is a wireless connection.

6. A system for monitoring information related to an activity, or characteristic, or location of a user having a device comprising a display, a microprocessor and a communication transceiver, the device comprising a server comprising a central processing unit, a memory, a clock, the memory having location data stored therein, and the central processing unit programmed to:
identify a user's identity using an identifying unit, wherein the identifying unit using at least one at least one scanning, sensing, or reading apparatus to obtain information relating to the user,
set a goal using a goal setting unit, wherein the goals setting unit enables the user or a third party to set at least one goal and associate monetary or other means of reward or punishment with the at least one goal;
track the at least on goal using a tracking and measurement unit, wherein the tracking unit tracks at least one goal or activity or characteristic or location;
communicate between at least two units using a communication unit, wherein the communication unit enables communication between the at least two units;
storing information about the user in a storage unit;
determines success or failure of the user in achieving the at least one goal based on at least one input from the tracking and measurement unit relating to the at least one goal using a decision unit; decision unit determines the penalty or reward based on the level of success or failure of the user; and
reward the user using a reward fulfillment unit, wherein the reward unit enables processing of payment information and reward corresponding to an output of the decision unit.

7. The system of claim 6, wherein at least one characteristics of the user is a physical characteristic which comprises at least one of height, weight, body fat, body mass, lean body mass, waist size.

8. The system of claim 6, wherein at least one characteristics of the user is a health characteristic which comprises at least one of blood pressure, blood sugar, blood glucose, A1C level, blood sucrose, insulin, cholesterol, LDL, HDL, blood oxygen, pulse, heart rate, body temperature, galvanic response etc.

9. The system of claim 6, wherein at least one characteristics of the user further comprises alcohol intake, drug or nicotine intake, blood or breath alcohol content, blood or breath nicotine content.

10. The system of claim 6, wherein the communication unit is a wireless connection.

11. A system for monitoring information related to an activity, or characteristic, or location of a user having a device comprising a display, a microprocessor and a communication transceiver, the device comprising a server comprising a central processing unit, a memory, a clock, the memory having location data stored therein, and the central processing unit programmed to:
identify a user's identity using an identifying unit, wherein the using at least one at least one of the following parameters: using one or more biometric sensors, scanning (reading) of any identifying cards of the user, scanning or reading a bar code or QR code or other graphical or numeric or alphanumeric code, scanning or reading a near-field communication device or tag (e.g., RFID tag, or NFC or Bluetooth tag), receiving identifying communication from a user's phone or mobile device, reading a bank card or credit card associated with the user, scanning or reading existing account of the user, scanning one or more devices used by the user, scanning the user's face through a still camera or a video (motion) camera, speech recognition, or audio recognition, or a password or passcode entered by the user
a goal setting unit, wherein the goal setting unit associates the measured physical or personal or vital or health characteristics of the user or the user's activity or location(s) visited, with a monetary reward or a monetary penalty;
a tricking and measurement unit, wherein the tracking unit tracks at least one goal or activity or characteristic or location associated with the user;
a communication unit, enabling transfer information between the units;
a storage unit for storing user information;
the decision unit, which determines success or failure (or level of success or failure) of the user to achieve his/her goal(s) based on the input from the tracking and measurement unit and the previously set goals by the user. The decision unit may also determine the penalty or reward based on the level of success or failure of the user;
a reward/punishment fulfillment unit, to enable processing of payment information and reward or punishment corresponding to an output of the decision unit. The reward/punishment fulfillment unit may also determine the penalty or reward based on the level of success or failure of the user

12. The system of claim 11, wherein at least one characteristics of the user is a physical characteristic which comprises at least one of height, weight, body fat, body mass, lean body mass, waist size.

13. The system of claim 11, wherein at least one characteristics of the user is a health characteristic which comprises at least one of blood pressure, blood sugar, blood glucose, A1C level, blood sucrose, insulin, cholesterol, LDL, HDL, blood oxygen, pulse, heart rate, body temperature, galvanic response etc.

14. The system of claim 11, wherein at least one characteristics of the user further comprises alcohol intake, drug or nicotine intake, blood or breath alcohol content, blood or breath nicotine content.

15. The system of claim 11, wherein the communication unit is a wireless connection.

16. A system for monitoring information related to an activity, or characteristic, or location of a user having a device comprising a display, a microprocessor and a communication transceiver, the device comprising a server comprising a central processing unit, a memory, a clock, the memory having location data stored therein, and the central processing unit programmed to use:
an identifying unit, wherein the identifying unit is used for identifying user's identity using at least one of the following: using one or more biometric sensors, scanning of any identifying cards of the user, scanning or reading a bar code or QR code or other graphical or numeric or alphanumeric code, scanning or reading a near-field communication device, receiving identifying communication from a user's phone or mobile device, reading a bank card or credit card associated with the user, scanning or reading existing account of the user, scanning one or more devices used by the user, scanning the user's face through a still camera or a video camera, speech recognition, or audio recognition, or a password or passcode entered by the user;
a goal setting unit, wherein the goal setting unit associates the measured physical or personal or vital or health characteristics of the user or the user's activity or at least one location visited, with a monetary reward or a monetary penalty;
a tracking and measurement unit, wherein the tracking unit tracks absolute or relative location of the user using at least one of a GPS, geolocation, triangulation data, accelerometer data, or wherein the tracking unit uses at least one of the following information to determine the user's activity: information of the merchant or credit card to determine goods purchased by the user, website tracking, cookie tracking, information from network providers regarding website visited, information about apps or software used by the user, cell phone data to track the activities of the user, cell phone data to track recent calls, cell phone data to track recent text messages;
a communication unit, enabling transfer information between the units;
a storage unit for storing information about the user;
the decision unit, which determines success or failure of the user to achieve the at least one goal based on the input from the tracking and measurement unit and the previously set goals by the user. The decision unit may also determine the penalty or reward based on the level of success or failure of the user; and
a reward fulfillment unit, to enable processing of payment information and reward or punishment corresponding to an output of the decision unit. The reward fulfillment unit may also determine the penalty or reward based on the level of success or failure of the user.

17. The system of claim 16, wherein certain location(s) or certain categories of location(s) are encouraged or discouraged

18. The system of claim 16, wherein certain web sites or certain applications (apps) or use of certain software are discouraged or encouraged.

19. The system of claim 16, wherein the time of entrance into a certain location or category of location and time of departure from a certain location or category of location or duration of stay in a certain location or category of location or number of visits to a certain location or category of location is tracked.

20. The system of claim 16, wherein the communication unit is a wireless connection.

21. A system for monitoring information related to an activity, or characteristic, or location of a user having a device comprising a display, a microprocessor and a communication transceiver, the device comprising a server comprising a central processing unit, a memory, a clock, the memory having location data stored therein, and the central processing unit programmed to use:
identifying unit, wherein the identifying unit is used for identifying user's identity;
a goal setting unit, wherein the goal setting unit associates the measured characteristics of the user with a monetary reward or a monetary penalty;
a tracking and measurement unit, wherein the tracking unit tracks at least one goal or activity or characteristic or location associated with the user;
a communication unit, enabling transfer information between the units;
the decision unit, enabling a measurement of at least one characteristics of the user by using at least one of a location trackers, a electronic medicals, a health record, a tracker of website;
a storage unit for storing information about the user; and
a payment collection unit, to enable processing of payment information corresponding to an output of the decision unit.

22. The system of claim 21, wherein at least one characteristics of the user is a physical characteristic which comprises at least one of height, weight, body fat, body mass, lean body mass, waist size.

23. The system of claim 21, wherein at least one characteristics of the user is a health characteristic which comprises at least one of blood pressure, blood sugar, blood glucose, A1C level, blood sucrose, insulin, cholesterol, LDL, HDL, blood oxygen, pulse, heart rate, body temperature, galvanic response etc.

24. The system of claim 21, wherein at least one characteristics of the user further comprises alcohol intake, drug or nicotine intake, blood or breath alcohol content, blood or breath nicotine content.

25. The system of claim 21, wherein the communication unit is a wireless connection.

26. A system for monitoring information related to an activity, or characteristic, or location of a user having a device comprising a display, a microprocessor and a communication transceiver, the device comprising a server comprising a central processing unit, a memory, a clock, the memory having location data stored therein, and the central processing unit programmed to used:
an identifying unit, wherein the identifying unit is used for identifying user's identity using at least one of the following: using one or more biometric sensors, scanning (reading) of any identifying cards of the user, scanning or reading a bar code or QR code or other graphical or numeric or alphanumeric code, scanning or reading a near-field communication device or tag (e.g., RFID tag, or NFC or Bluetooth tag), receiving identifying communication from a user's phone or mobile device, reading a bank card or credit card associated with the user, scanning or reading existing account of the user, scanning one or more devices used by the user, scanning the user's face through a still camera or a video (motion) camera, speech recognition, or audio recognition, or a password or passcode entered by the user;
a goal setting unit, wherein the goal setting unit associates the measured physical or personal or vital or health characteristics of the user or the activity of the user or locations visited or avoided by the user with a monetary reward or a monetary penalty;
a tracking and measurement unit, wherein the tracking unit tracks at least one goal or activity or characteristic or location associated with the user;
a communication unit, enabling transfer information between the units;
the decision unit, enabling a measurement of at least one characteristics of the user;
a storage unit for storing user information; and
a payment collection unit, to enable processing of payment information corresponding to an output of the decision unit, wherein the payment collection unit make a video call to the user before making the payment.

27. The system of claim 26, wherein at least one characteristics of the user is a physical characteristic which comprises at least one of height, weight, body fat, body mass, lean body mass, waist size.

28. The system of claim 26, wherein at least one characteristics of the user is a health characteristic which comprises at least one of blood pressure, blood sugar, blood glucose, A1C level, blood sucrose, insulin, cholesterol, LDL, HDL, blood oxygen, pulse, heart rate, body temperature, galvanic response etc.

29. The system of claim 26, wherein at least one characteristics of the user further comprises alcohol intake, drug or nicotine intake, blood or breath alcohol content, blood or breath nicotine content.

30. The system of claim 26, wherein the communication unit is a wireless connection.

31. A system for monitoring information related to an activity, or characteristic, or location of a user having a device comprising a display, a microprocessor and a communication transceiver, the device comprising a server comprising a central processing unit, a memory, a clock, the memory having location data stored therein, and the central processing unit programmed to used:
an identifying unit, wherein the identifying unit is used for identifying user's identity using at least one of the following: using one or more biometric sensors, scanning (reading) of any identifying cards of the user, scanning or reading a bar code or QR code or other graphical or numeric or alphanumeric code, scanning or reading a near-field communication device or tag (e.g., RFID tag, or NFC or Bluetooth tag), receiving identifying communication from a user's phone or mobile device, reading a bank card or credit card associated with the user, scanning or reading existing account of the user, scanning one or more devices used by the user, scanning the user's face through a still camera or a video (motion) camera, speech recognition, or audio recognition, or a password or passcode entered by the user;
a goal setting unit, wherein the goal setting unit associates with a physical or personal or vital or health characteristics of the user with a monetary reward or a monetary penalty;
a tracking and measurement unit, wherein the tracking unit tracks absolute or relative location of the user using at least one of a GPS, geolocation, triangulation data, accelerometer data, or wherein the tracking unit uses at least one of the following information to determine the user's activity: information of the merchant or credit card to determine goods purchased by the user, website tracking, cookie tracking, information from network providers regarding website visited, information about apps or software used by the user, cell phone data to track the activities of the user, cell phone data to track recent calls, cell phone data to track recent text messages;
a communication unit, enabling transfer information between the units;
the decision unit, enabling a measurement of at least one physical or health or personal or other characteristics of the user; and
a payment collection unit, to enable processing of payment information corresponding to an output of the goal setting unit, wherein the payment collection unit make a voice or video call to the user before making the payment.

32. The system of claim 31, wherein at least one characteristics of the user is a physical characteristic which comprises at least one of height, weight, body fat, body mass, waist size.

33. The system of claim 31, wherein at least one characteristics of the user is a health characteristic which comprises at least one of blood pressure, blood sugar, cholesterol, blood oxygen, body temperature, heart rate.

34. The system of claim 31, wherein at least one characteristics of the user further comprises alcohol intake, drug or nicotine intake.

35. The system of claim 32, wherein the communication unit is a wireless connection.

36. A system for monitoring information related to an activity, or characteristic, or location of a user, wherein the system comprises:
identifying user's identity using at least one of the following: using one or more biometric sensors, scanning (reading) of any identifying cards of the user, scanning or reading a bar code or QR code or other graphical or numeric or alphanumeric code, scanning or reading a near-field communication device or tag (e.g., RFID tag, or NFC or Bluetooth tag), receiving identifying communication from a user's phone or mobile device, reading a bank card or credit card associated with the user, scanning or reading existing account of the user, scanning one or more devices used by the user, scanning the user's face through a still camera or a video (motion) camera, speech recognition, or audio recognition, or a password or passcode entered by the user;
a storage unit for storing user information;
goal setting at least one of a physical or personal or vital or health characteristics of the user or the user's activity or location visited or avoided with a monetary reward or a monetary penalty;
a tracking and measurement unit, wherein the tracking unit tracks absolute or relative location of the user using at least one of a GPS, geolocation, triangulation data, accelerometer data, or wherein the tracking unit uses at least one of the following information to determine the user's activity: information of the merchant or credit card to determine goods purchased by the user, website tracking, cookie tracking, information from network providers regarding website visited, information about apps or software used by the user, cell phone data to track the activities of the user, cell phone data to track recent calls, cell phone data to track recent text messages;
a communication unit, enabling transfer information between the units, utilizing the Internet; and
paying corresponding to an output of the decision unit, wherein the payment is in the form of cash/credit, goods (e.g., gift card) or services.
